(19) United States
(12) Patent Application Publication
(10) Pub. No.: US 2008/0283639 A1
(43) Pub. Date: Nov. 20, 2008

(54) Method for Operating a Fragmentation System and System Therefor

(75) Inventors: Wolfgang Frey, Karlsruhe (DE); Ralf Strassner, Karlsruhe (DE); Andreas Schormann, Alzenau (DE); Kurt Giron, Mombris (DE); Harald Giese, Stutensee (DE)

Correspondence Address: VENABLE LLP, P.O. BOX 34385, WASHINGTON, DC, 20043-9998, US

(73) Assignee: Forschungszentrum Karlsruhe GmbH, Karlsruhe (DE)

(21) Appl. No.: 10/571,459

(22) PCT Filed: Jul. 28, 2004
(86) PCT No.: PCT/EP04/08414

§ 371 Date: Dec. 10, 2007

(30) Foreign Application Priority Data
Sep. 13, 2003 (DE) 103 42 376.1

(51) Int. Cl. B02C 23/00

(52) U.S. Cl. 241/20

(57) ABSTRACT

The invention relates to a method for operating an electrodynamic fragmentation system. The fragmentation product arranged in the process fluid is permanently suspended and forms a suspension with the process fluid. The portion of the processed fragmentation product which attains the target particle size or smaller is discharged from the reaction vessel and the fragmentation product exceeding the target particle size is supplied to the reaction area. The fragmentation system comprises a chargeable electric energy store, a pair of electrodes connected thereto, and both ends thereof are arranged at a distance from each other in the process fluid contained in the reaction vessel. The fragmented product is separated in a solid and liquid manner in a separator in the electrode intermediate chamber until it reaches the target particle size and is smaller than the target particle size and the prepared process fluid is guided back into the reaction vessel.

The invention relates to a method for operating a fragmentation system to achieve a more effective grinding of a fragmentation product, consisting of mineral and/or brittle materials, into target particle sizes of <5 mm, as well as to a fragmentation system operating on the basis of said method.

The technical principle used for the fragmentation system is based on the FRANKA technology (FRANKA=Fragmentieranlage Karlsruhe=fragmentation system Karlsruhe), as described in reference DE 195 34 232. The fragmentation system consists of an electric energy store which is discharged in a pulsed mode into a reaction vessel and into the fragmentation products, which are submerged in a processing fluid in the region between two electrode ends that are positioned at a distance to each other, the reaction zone.

For the grinding of the material by means of the fragmentation system, the fragmentation product positioned between the two electrode ends in the processing fluid is fragmented with the aid of disruptive electric breakdowns and the shockwaves generated as a result. These mineral and/or brittle materials can have a uniform structure such as rock/stone or glass, or they can have a conglomerate structure such as sedimentary rock and concrete. The target particle sizes are <5 mm and preferably even <2 mm. Fragmented particles below this particle size are extracted from the process area by means of filter cartridges, e.g. as for the gravel and sand production, or the grinding of color bodies, or in general for materials that are not compound materials. Fragmentation products such as products obtained when tearing down a building are continuously filled back into the process area to replenish the amount of fragmentation product which is removed.

The fragmentation system comprises an electric energy store that is discharged in the form of a pulsed discharge via a spark gap into a load, wherein this load is the processing fluid with therein submerged fragmentation product in the region between the electrodes. The two electrodes are positioned opposite each other in the processing fluid, at a predetermined, adjustable distance relative to each other, wherein the electrode ends are completely submerged. The reaction vessel normally contains the processing fluid into which the product to be fragmented is poured and from which the fragmented product with particle sizes at or below the predetermined threshold value is subsequently removed.

So far, the assumption has been that as a result of the discharges into the region between the two electrode ends, primarily the high-voltage electrode and the bottom and/or a partial region thereof, the fragmentation product is repeatedly stirred up sufficiently during these pulsed discharges. However, a series of experiments has shown that the material is stirred up only insufficiently.

It is therefore the object of the present invention to achieve a more effective fragmentation of the product positioned in the region between the electrodes by keeping this product suspended to save processing time and energy.

With respect to the method, this object is solved by the step disclosed in claim 1 of stirring up the fragmentation product in the region filled with the processing fluid, meaning the space between the electrode ends and the bottom of the reaction vessel with thereon deposited fragmentation product. The fragmentation product in the processing fluid is kept continually suspended, thus forming a suspension together with the processing fluid. From this suspension, the share of the processed fragmentation product which matches or falls below the target particle size is then discharged from the reaction vessel while the share of the fragmentation product which exceeds the target particle size—meaning the rough particles—is fed back into the reaction zone.

This object is solved for the subject matter with a fragmentation system according to the characterizing features disclosed in claim 7. A device for keeping the fragmentation product suspended in the processing fluid is mounted either on or in the reaction vessel because no air with a relative dielectric constant ∈ᵣ near 1, as well as no gas with the same ∈ᵣ, should be allowed to enter the processing chamber. Furthermore mounted on or in the reaction vessel is a device for transferring out the share of the suspended fragmentation product with particle sizes starting at or below the target particle size. Subsequently, this share is supplied to a device for the solid/fluid separation while the share of the fragmentation product with particle sizes above this target particle size is returned to the reaction vessel. For this, at least one return-flow line for the processing fluid empties into the reaction vessel.

Additional measures for a more advantageous, case-by-case realization of the fragmentation process are described in method claims 2 to 6. To keep the fragmentation product effectively suspended, claim 2 discloses the use of hydrodynamic measures, such as creating flows, while claim 3 describes the use of mechanical measures such as stirring or shoveling. The flow direction and flow intensity, as well as the stirring and shoveling speed, can be controlled and adjusted for optimizing the fragmentation process.

According to claim 4, the upcurrent classification method is used for transferring out the processed share of the fragmentation product. Following a solid/fluid separation, the rough particle share of the product, for which the particle size exceeds the target particle size, is then returned to the reaction vessel. According to claim 5, the hydro-cycloning method is used for this separation. According to claim 6, finally, this separation is achieved by using different types of filters submerged in the processing fluid, such as filter baskets or filter cartridges.

The device claims 8 to 12 describe measures for advantageously outfitting the fragmentation system.

Maintaining the suspension is important for achieving a continuous and economic operation of the fragmentation system. For this, the fragmentation system must be set up and adjusted according to claim 8 in such a way that the product to be fragmented is kept suspended in the processing fluid without forming dead zones. Claim 9 describes an upcurrent classification unit which is set up for separating the fragmentation product while claim 10 describes the use of a hydro cyclone as an alternative solution for separating the fragmented products. Claim 11 finally describes devices known in the field of screening technology, for example filters in the form of baskets, cartridges, and the like. In that case, owing to the effect of the shock waves generated by the electrical discharge, the distance to the region between the electrodes is adjusted to allow for an effective cleaning, while simultaneously avoiding destruction, wherein the intensity decreases at the rate of 1/r² starting with the source of the shock waves.

According to claim 12, the suspension is maintained with inflow nozzles through which the processing fluid that is recovered during the solid/fluid separation is guided back into/flows back into the reaction vessel, in a controlled and directed manner.

Owing to these measures, fine-particle shares of the fragmentation product can be kept suspended in the processing fluid during the fragmentation process and can be returned again and again to the region of electrical discharge. For this, the suction cartridge, or also the suction cartridges, is (are) positioned such that the fragmentation product will impact with high probability with the cartridges, so that sufficiently small particle sizes are extracted. With each discharge operation, fragments suspended from the screen of the suction cartridge, which are still too large, are shaken off by the shock wave(s) triggered by the discharge channel or channels.

The method and an exemplary embodiment of a fragmentation system are explained in the following with further detail and with the aid of the drawing. One embodiment described herein, meaning the embodiment with “circular piping,” is specifically disclosed in the method claim 2 and the device claim 8. Based on preliminary experiments, this embodiment represents a favorable solution with respect to flow technology. Additional solutions to be considered can include the use of a directional pipe and/or a pipe bundle. In any case, attention must be paid when designing and setting up the system to avoid dead flow zones in which fine particles could collect and could be deposited.

The reaction vessel itself is the only part of the fragmentation system which is shown herein. The electrical components, meaning the charging device, the energy store, and the spark gap are components known among other things from the above-cited prior art sources. The electrical energy store primarily takes the form of a bank of capacitors, with the energy being discharged via spark gaps in-between and with the aid of automatic disruptive breakdowns, discharged onto the load in the region between the electrodes in the reaction vessel. In FRANKA-type systems, the electrical component is a Marx generator, for which the electrical charging and discharging method is known from the field of electrical high-power/voltage pulse technology.

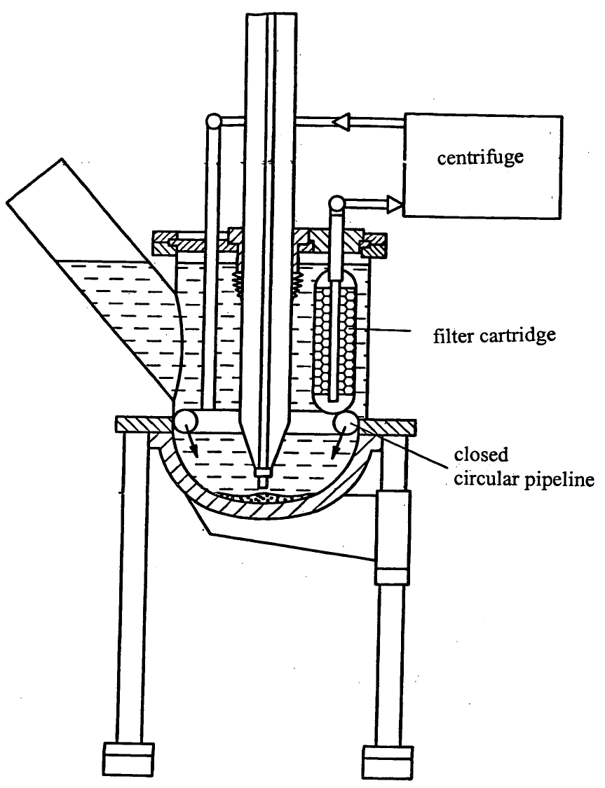

FIG. 1 shows the barrel-shaped reaction vessel which rests on support legs. The high-voltage electrode, which is electrically insulated up to its exposed end region, projects through the lid into the reaction vessel. The high voltage electrode is not held rigidly in the lid, so that the impulse and shock wave effect, caused by the electrical discharge, cannot be transmitted. The exposed, metallic end region is completely submerged in the processing fluid inside the reaction vessel, which in this case is water, wherein even the covering insulation part projects far into the water. No creep distances should form thereon during a long-term operation. With this embodiment, the bottom of the reaction vessel forms the counter electrode that curves downward, for example in the manner of a ball, wherein this can refer to the complete bottom or only a central region thereof. In any case, the counter electrode is connected to a fixed potential, the reference potential, which generally is the earth potential. A centrally deposited fragmentation product is indicated on the earth potential electrode. Starting with the tip of the heating voltage electrode, the discharge channel that forms should extend through the fragmentation product to the earth potential electrode and/or a cone-shaped region of discharge channels should extend in the same way from the front of the high-voltage electrode toward the center of the bottom region.

Projecting through the lid of the reaction vessel are the water supply line and the discharge line for the water loaded with fragmentation product, which arrives from the filter cartridge. In order to optimize the fragmentation processes, the intensity of the flow responsible for stirring up the product and its direction at the start of the flow are controlled. For this embodiment, the device for generating a flow and stirring up the fragmentation product surrounds the high-voltage electrode coaxially. The feed line feeds into the coaxially arranged closed circular pipeline. The closed circular pipeline is electrically secure and is attached to the vessel wall, so that it can resist shock waves with tolerable expenditure.

Depending on the fragmentation product, the outflow direction of the nozzles can be adjusted and/or re-adjusted to obtain an optimum stirring up during the operation. The flow intensity is adjusted with the aid of a pump, which pumps the pure processing fluid into the closed circular pipeline. The nozzles direct the flows along the bottom and toward the bottom center. In this way, the fragmentation product previously deposited on the bottom or the product being deposited thereon is continually stirred up and kept suspended, thus avoiding areas without flow in the complete water volume.

The filter cartridge is completely submerged in water. The mesh width of the grid surrounding the filter cartridge determines the largest particle size that can be extracted. The suspension flowing through the filter cartridge is then separated inside the centrifuge, indicated on the right side of the FIGURE, into the fluid share, meaning the processing water, and the solid particle share. The water is returned to the reaction vessel by way of the feed line for the closed circular pipeline, wherein fresh water can be added along the way.

New fragmentation material is filled in/poured in through the pipe section that projects from the reaction vessel on the left side of the FIGURE.

Depending on the size of the reaction vessel, maintenance and repair operations are considerably facilitated if the bottom of the reaction vessel can be screwed off and can be moved to the side by means of the projecting arm, which is attached pivoting to the support leg, shown on the right side of the FIGURE.

1. A method for operating a fragmentation system for a more effective grinding of mineral and/or brittle materials to target particle sizes of <5 mm, wherein the fragmentation system comprises an electric energy store that is discharged in a pulsed mode into a reaction vessel and into the fragmentation product, which is submerged in a processing fluid between two electrode ends that are arranged opposite each other at a distance, the reaction zone,
characterized in that
the fragmentation product in the processing fluid is kept continually suspended and thus forms a suspension together with the processing fluid,
from this suspension, the share of the processed fragmentation product at or below the target particle size is extracted and removed from the reaction vessel, and
that any fragmentation product for which the particle size exceeds the target particle size—meaning the rough particle shares—is returned to the reaction zone.

2. The method according to claim 1, characterized in that the fragmentation product that is submerged in the processing fluid inside the reaction vessel is kept hydro-dynamically suspended.

3. The method according to claim 1, characterized in that the fragmentation product submerged in the processing fluid inside the reaction vessel is kept suspended with the aid of mechanical means.

4. The method according to claim 2, characterized in that the share of the processed fragmentation product in the reaction vessel which is at or below the approximate target particle size is removed by means of an upcurrent classification, is subsequently subjected to a solid/fluid separation, and that the material share containing rough particles exceeding the target particle size is then returned to the reaction vessel.

5. The method according to claim 2, characterized in that the share of processed fragmentation product in the reaction vessel which is at or below the target particle size is removed with the aid of the hydro-cycloning method, is subsequently subjected to a solid/fluid separation, and that the material share containing rough particles exceeding the target particle size is then returned to the reaction vessel.

6. The method according to claim 2, characterized in that the share of the processed fragmentation product in the reaction vessel which is at or below the target particle size is removed with the aid of filters submerged into the processing fluid and that the material share containing rough particles exceeding the target particle size is then returned to the reaction vessel.

7. A fragmentation system for realizing the method according to claim 1, said system comprising:
a re-chargeable electric energy store;
a thereto connected pair of electrodes and, wherein the two ends of the electrodes are arranged at a distance to each other inside a reaction vessel, provided with processing fluid,
wherein one of the two electrodes is connected to reference potential and the other one—the high-voltage electrode—can be admitted by means of an output switch with pulsed high-voltage from the energy store,
characterized in that:
a device for keeping the fragmentation product suspended in the processing fluid is mounted on or in the reaction vessel;
a device is mounted on or in the reaction vessel for transferring out of the suspension the share of the fragmentation product that is at or below the target particle size, for supplying this share to a solid/fluid separation device, and for returning the share of the fragmentation product with particles sizes exceeding the target particle size to the reaction vessel,
at least one return-flow line for processing fluid is provided which empties into the reaction vessel.

8. The fragmentation system according to claim 7, characterized in that the device for maintaining the suspension moves the fragmentation product suspended in the processing fluid through the reaction zone, without allowing dead zones to form.

9. The fragmentation system according to claim 8, characterized in that the device for transferring the shares of the fragmentation product at or below the target particle size out of the suspension is the processing vessel embodied as upcurrent classifier.

10. The fragmentation system according to claim 8, characterized in that the device for transferring the shares of the fragmentation product at or below the target particle size out of the suspension is the processing vessel embodied as hydro-cyclone.

11. The fragmentation system according to claim 8, characterized in that that the device for transferring the shares of the fragmentation product at or below the target particle size out of the suspension is at least one filter, designed for filtering out the target particle size.

12. The fragmentation system according to claim 9, characterized in that the processing fluid from the solid/fluid separation is returned to the reaction vessel by means of one or several nozzles, such that the product in the reaction zone is kept completely suspended if possible.
